(19) United States
(12) Patent Application Publication
(10) Pub. No.: US 2005/0076097 A1
(43) Pub. Date: Apr. 7, 2005

(54) Dynamic web page referrer tracking and ranking

(76) Inventors: Robert John Sullivan, Kelowna (CA); Gordon Charles Hotchkiss, Kelowna (CA); Douglas Kent Wilson, Kelowna (CA)

Correspondence Address: Chernoff Vilhauer McClung & Stenzel, L.L.P., 1600 ODS Tower, 601 SW Second Avenue, Portland, OR, 97204-3157, US

(21) Appl. No.: 10/670,455

(22) Filed: Sep. 24, 2003

(51) Int. Cl. G06F 15/16

(52) U.S. Cl. 709/218

(57) ABSTRACT

The invention dynamically produces alternate referrer pages substantially similar to pages previously viewed, through a web browser, by a visitor who linked to a target web page via a link on the previously viewed pages. When the browser links to the target page, a referrer URL is obtained for the referrer page from which the browser loaded the target page. The referrer URL is stored in a queue. The queue is inspected regularly. If the queue contains an unexamined entry, a request for that entry's referrer URL is executed to obtain the alternate referrer pages. The IP address of the computer running the browser is used to derive a country code corresponding to the IP address. The referrer URL request can be issued through a computer in a geographic region corresponding to the country code so that geographic biasing of the previously viewed pages will be reflected in the alternate pages.

### TECHNICAL FIELD

This invention dynamically produces alternate referrer pages substantially similar to pages previously viewed, through a web browser, by a visitor who linked to a target web page via a link on the previously viewed pages. The alternate referrer pages can be analyzed to obtain information about the target web page and the link to the target web page.

### BACKGROUND

Search engines are used to find information on the Internet. A typical search engine utilizes a server computer, or a collection of servers, to index links to Internet web pages and store the indexed results. Each link is a universal resource locator (URL) an address which uniquely identifies an Internet resource. A search engine user types one or more search keywords into a search dialog box. The keywords are selected by the user to indicate the nature of the web page content the user wants to find. The search engine compares the user's keywords with its index and displays one or more search results pages containing links to web pages having content purportedly corresponding to the keywords. The user reviews the displayed links and decides which, if any, of them to follow in order to see the web page(s) corresponding to the links. Familiar search engines include Google™, Infoseek™, AltaVista™, HotBot™ and AllTheWeb™.

Directories (sometimes called indexes), such as Yahoo™, are also used to find information on the Internet. Like search engines, directories utilize a server or a collection of servers to index web pages and display links to pages corresponding to a user's search query. As used herein, the term “search engine” includes directories and indexes.

Some search engine providers allow web page owners to submit a description of their web page and a link to the page for inclusion in the search engine's index. Such providers may manually review the contents of each submitted page before adding it to the search engine's index—sometimes editing the submitted description and categorizing it. However, many search engines use automated web page indexers (sometimes called spiders, web crawlers or web robots) to automatically locate web pages and index links to them.

As the Internet grew, web page owners realized that the number of visitors to their pages would increase if the links to their pages appeared near the top of the search results page(s) of links returned by a search engine. Web page owners accordingly developed techniques to influence the results produced by search engines in response to particular user queries. For example, one technique, called “keyword spamming,” involves placement of many (often hundreds) of keywords on a web page, formatted in the same colour as the page background, making the keywords invisible to humans while maintaining their visibility to search engines' automated web page indexers. These techniques often skewed the search results by causing links to potentially more relevant pages to appear lower in the list of links returned by the search engine. Search engine providers responded by developing filters to exclude pages using such techniques from their search engine indices. A vicious cycle ensued, with web page owners developing more sophisticated results-influencing techniques, search engine providers responding with more sophisticated filters, and so on.

The commercial success of a web page was initially believed to be directly proportional to the number of visitors to the page. But, web page owners soon realized that there is no strong correlation between the number of visitors to a web page and the number of sales or sales leads generated by the page. A modern web page's commercial success is more conventionally measured in terms of the number of “converted visitors” to the page. A converted visitor is one who completes a “conversion action” predefined by the web page owner, such as registering to receive a newsletter or making a purchase. The number of converted visitors to a web page is believed to have a direct correlation to sales, especially if a sale is the attribute used to identify a page's converted visitors as such.

Search engines quickly became primary referrers of web page visitors. In general, a “referrer” is the means whereby a visitor reaches or comes to know about a target page. For example, a magazine advertisement displaying a target page's URL is a referrer for that web page. A person seeing the advertisement could type the URL directly into a web browser's address field to reach the target web page. As another example, an email message containing a link to or the URL of a target web page is a referrer for that web page. Search engines are also referrers: they provide search results pages of links which can be used to reach target web pages. For purposes of illustration only, this application deals with search engine referrers. However, other referrers such as partner sites, related industry sites, community sites or sites that host contextual advertising may all refer traffic to a target web page. The invention is of general application and encompasses all such referrers.

A typical search engine search results page contains one or more referrer URLs. Each referrer URL is usually encoded by the search engine with information such as the search engine's identity, the page number of the search engine search results page containing the particular referrer URL, and the keyword(s) the visitor typed to cause the search engine to produce the results page. This makes it possible to determine which search engines and keywords are referring visitors to a target web page.

Some search engine operators accept payment from web page owners in consideration for ensuring that a link to the owner's web page appears prominently on search results pages produced by the search engine in response to certain keywords. Such “sponsored” links typically appear above or to the right of any non-sponsored links on the search results pages, and may be labeled “sponsored” links or the like. Sponsored links are sometimes called PFP (pay for placement, pay for performance, pay for position or pay for prominence) links.

The owner of a target web page can use a “ranking report” to determine the positions of links to the target page on search results pages produced by search engines in response to particular keywords. It is important to assess such positioning because the likelihood that a potential visitor will find and click on a link to the target page is reduced if the link appears too far from the top of the search results page(s) of links returned by a search engine. To produce a ranking report, a series of results pages are first obtained by sending queries containing the keyword(s) of interest to each search engine of interest. The search engine search results page(s) produced for each search engine and keyword combination are then analyzed to determine the position of the link to the target web page relative to the top of the results page(s)—assuming a link to the target web page appears on the results page(s). The position so determined is the “rank” of the target web page for the particular search engine and keyword combination. By analyzing ranking reports for different keywords the target web page owner can utilize techniques well known to persons skilled in the art to devise a strategy for optimizing the target web page so as to improve the target web page's ranking for selected search engine and keyword combinations.

A limitation of the foregoing technique is that the keywords must be chosen in advance and therefore may not be representative of all search engine keywords which visitors or potential visitors actually employ in attempting to find web pages having content like that of the target web page. This limitation can be overcome by searching the target web page server's log files for referrer URLs—if the log files are available, which is not always the case. As previously explained, each referrer URL identifies the referring search engine and typically includes the keyword(s) the visitor typed into the search engine. The search engine's identity and the keyword(s) can thus be programmatically extracted from each referrer URL. The extracted details can then be used to produce a ranking report, in conventional fashion.

By way of example, suppose the owner of the web site accessible via the URL/link http://www.pearlmansjewelers.com/ requires a ranked report of various keywords which can be used to access various target web pages on the site via various search engines. In accordance with the prior art, a list of the keywords of interest is compiled for each target web page, namely the keyword(s) which potential visitors to the target web page are expected to type into a search engine to potentially cause the search engine to include a link to the target web page in the search engine's search results page(s), due to inclusion of the keyword(s) in the target web page's text or meta tags and consequential inclusion of the target web page in the search engine's index.

Table 1 (FIG. 1A) lists some exemplary keywords. Each keyword consists of one or more words and may be a phrase. Thus, the keyword “Michael B. rings” might be used by a potential visitor interested in rings designed by someone named Michael B.; the keyword “Alexander Primak” might be used by a potential visitor interested in anything concerning someone named Alexander Primak; and, the keyword “Kieselstein jewelry” might be used by a potential visitor interested in jewelry designed, sold, etc. by someone named Kieselstein.

A list of the search engines of interest is also complied, namely the search engines potential visitors to the web page are expected to use in an effort to obtain a link to the target web page. Table 2 (FIG. 1B) lists some exemplary search engines and their URLs.

Each listed keyword is then searched via each listed search engine to obtain one or more corresponding search engine search results pages. For example, Table 3 (FIG. 1C) lists search command URLs produced by searching the Table 1 keywords using selected ones of the Table 2 search engines. The first N links on the results page(s) produced by each search command URL are then reviewed to locate a link to the target web page, where N is a predefined integer representative of the number of results page(s) links a typical visitor is expected to be willing to scan in order to locate a link of interest. For example, N=30 might be selected. If a link to the target web page is located within the first N links on the results page(s), then the ordinal position or rank (i.e. 1^{st}, 2^{nd}, 3^{rd}, etc.) of the located link relative to the first link on the results page(s) is noted and recorded. If the link is identified on the results page(s) as a sponsored link it is ignored, because sponsored links already have priority ranking. Table 4 (FIG. 1D) lists URL links to target web pages obtained for each of the Table 1 keywords using each of the Table 2 search engines and shows each link's ordinal position (i.e. rank) on the results page(s) containing that link, together with the number of the results page containing that link. For example, the first Table 4 entry indicates that the listed target web page URL appears at position 18 on page 2 (i.e. the 8th link on the second page, assuming 10 links per page) of the results pages obtained by typing the keyword “Michael B. rings” into the AltaVista™ search engine. It is useful to include the number of the results page containing the target web page URL, since research suggests a reduced likelihood that potential visitors will find and click on a link appearing on the second or subsequent pages in a set of results pages.

Ranking reports produced by prior art techniques which require a priori determination of keywords may be inaccurate. Specifically, predetermined keywords may not be the keywords visitors actually use to locate and link to the target web page, thus limiting the utility of ranking results obtained via such techniques as an aid to optimization of the target web page. As previously mentioned, this limitation can be overcome by programmatically extracting keywords from referrer URLs in the target web page server's log files.

However, log-file based prior art techniques can only rank a target web page as of the time when the search results pages are obtained via the prior art technique. That time may be days, weeks or even months (depending on the age of the web server's log files) after the time when a visitor to the target web page typed the keywords into a search engine to obtain a link to the target web page and produce a corresponding log file entry. Consequently, due to the rapidly changing nature of web pages accessible via the Internet, search engine search results pages obtained for a particular log file entry via prior art techniques may differ considerably from those obtained by the visitor for whom the log file entry was created. This causes potentially inaccurate ranking of the target web page by the prior art techniques, since the target web page's rank should ideally reflect the position of the target web page's link on the results page(s) the visitor actually saw, not the link's position at some later time.

As an example, consider the following log file entry for the web site accessible via the URL http://www.pearlmansjewelers.com/, which identifies a referral from the Google™ search engine:

2003-07-17 08:03:31 202.88.163.10 - 199.60.252.241 80 GET /nfcathy_{—}
carmendy.htm - 200 5846 395 641 HTTP/1.1 www.pearlmansjewelers.
com Mozilla/4.0+(compatible; +MSIE+5.01;+Windows+NT+5.0) -
http://www.google.com/search?hl=en&lr=&ie=UTF-8&q=cathy+
carmendy&spell=1

The referrer URL portion of the above log file entry is:

http://www.google.com/search?hl=en&lr=&ie=UTF-8&q=cathy+
carmendy&spell=1

The referrer URL reveals that the visitor typed a search phrase consisting of the keywords “cathy” and “carmendy” into the Google™ search engine. By requesting the same referrer URL (for example by copying it and pasting it into a web browser's address field) one can obtain Google™ search engine search results page(s) similar to the page(s) obtained by the visitor for whom the log file entry was created. (The results page(s) may not be exactly the same as those obtained by the visitor, depending on the time lapse since the visitor's search was performed, due to the ever-changing nature of web pages accessible via the Internet, possible intervening updates to the Google™ search engine's index, etc.) The results page(s) so obtained are then inspected to determine the position of the link to the target web page. That position is the target web page's “rank” for the keyword phrase “cathy carmendy” using the Google™ search engine.

The foregoing log file-based technique is useful only if the relevant log files and the expertise to interpret them, or suitable software tools—or both—are available, which is not always the case. Moreover, log files are sometimes made available only on a weekly or monthly basis, in which case the ranking report's contents may be stale by the time the log files are obtained and analyzed.

This invention addresses the foregoing shortcomings by dynamically providing a continuously updated ranking for each search engine and keyword combination actually used to access a target web page, without the need for access to any log files.

### SUMMARY OF INVENTION

The invention dynamically produces alternate referrer pages substantially similar to referrer pages previously viewed, through a web browser, by a visitor who linked to a target web page via a link on the previously viewed pages. When the browser links to the target web page, a referrer URL is obtained for the page from which the browser loaded the target web page. A request for the referrer URL is then issued to obtain the alternate referrer pages.

In a preferred embodiment, the invention dynamically produces alternate search engine search results pages substantially similar to pages previously viewed, through a web browser, by a visitor who supplied keywords to a search engine via a web browser and linked to a target web page via a link on the previously viewed pages. When the visitor's browser links to the target web page, a referrer URL is obtained for the page from which the browser loaded the target web page. The referrer URL is parsed to determine whether it identifies a search engine. If the referrer URL identifies a search engine, the referrer URL is further parsed to locate any keywords contained in the referrer URL. A queue entry containing the referrer URL, search engine identifier, and keywords is created. The queue is inspected regularly. If the queue contains an unexamined entry, a search request for the keywords contained in the unexamined entry is issued to the search engine identified by that entry to obtain the alternate results pages.

Preferably, the IP address of the computer running the web browser is obtained and used to derive a country code corresponding to the IP address. The derived country code is included in the queue entry with the referrer URL, search engine identifier, and keywords. The search request for each queue entry is issued through a computer located in a geographic region corresponding to that entry's country code.

The alternate results pages can be searched to locate a link to the target web page and to determine that link's rank. The search engine, keyword and rank information can be stored in a database, together with the link to the target web page. The database provides a continuously updated, ranked, indication of keyword(s) actually used by the target web page's visitors to access the web page via particular search engines.

### BRIEF DESCRIPTION OF DRAWINGS

FIGS. 1A, 1B, 1C and 1D respectively tabulate exemplary keywords, search engines, search commands and ranked results obtainable in accordance with prior art ranking techniques.

FIG. 2 is a block diagram overview of the sequence of operations performed in dynamically tracking and ranking web page referrer URLs in accordance with the invention.

FIG. 3 is a flowchart depiction of the sequence of operations performed by the invention's target web page-embedded tracking module.

FIG. 4 is a flowchart depiction of the sequence of operations performed by the invention's visits logger module.

FIG. 5 is a flowchart depiction of the sequence of operations performed by the invention's search engine identification module.

FIG. 6 is a flowchart depiction of the sequence of operations performed by the invention's search engine results page parser module.

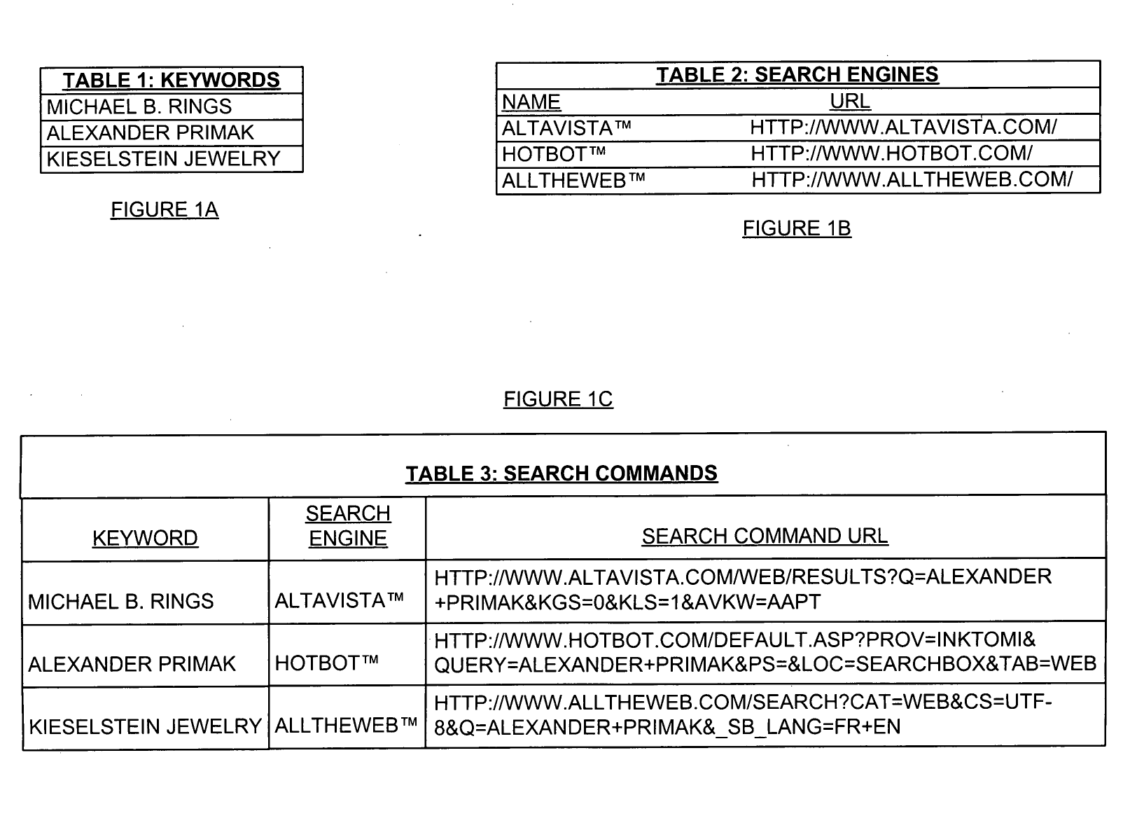

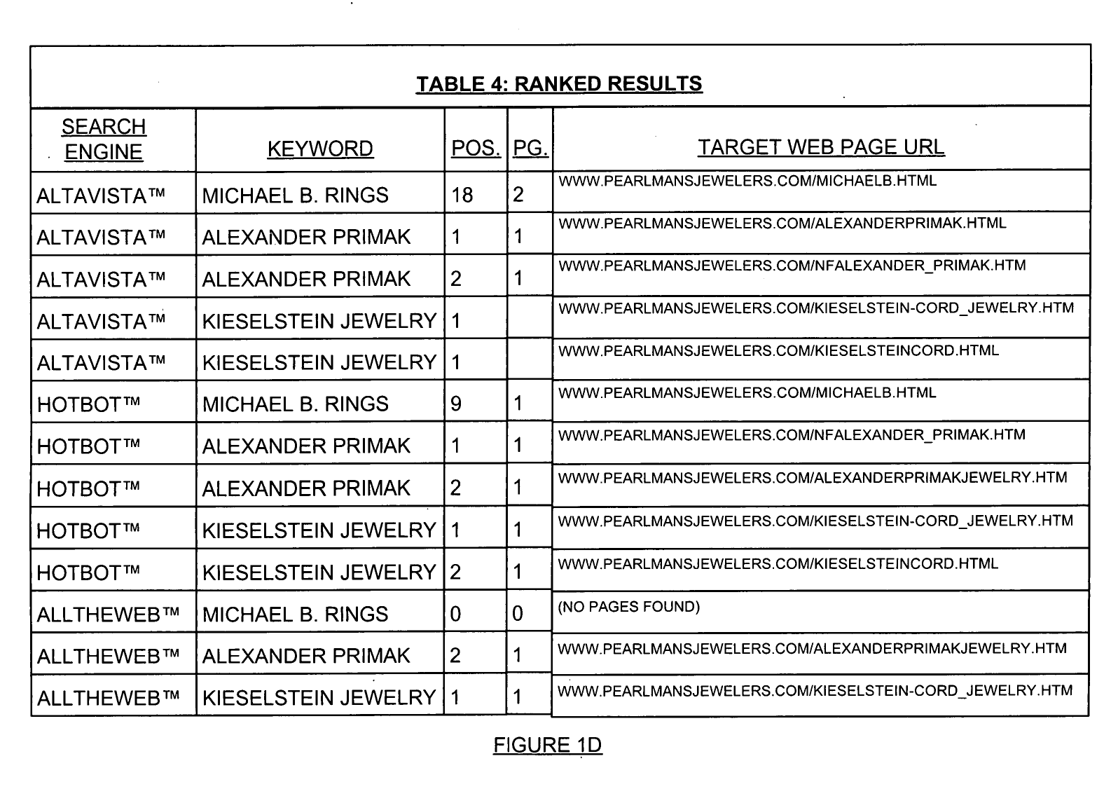

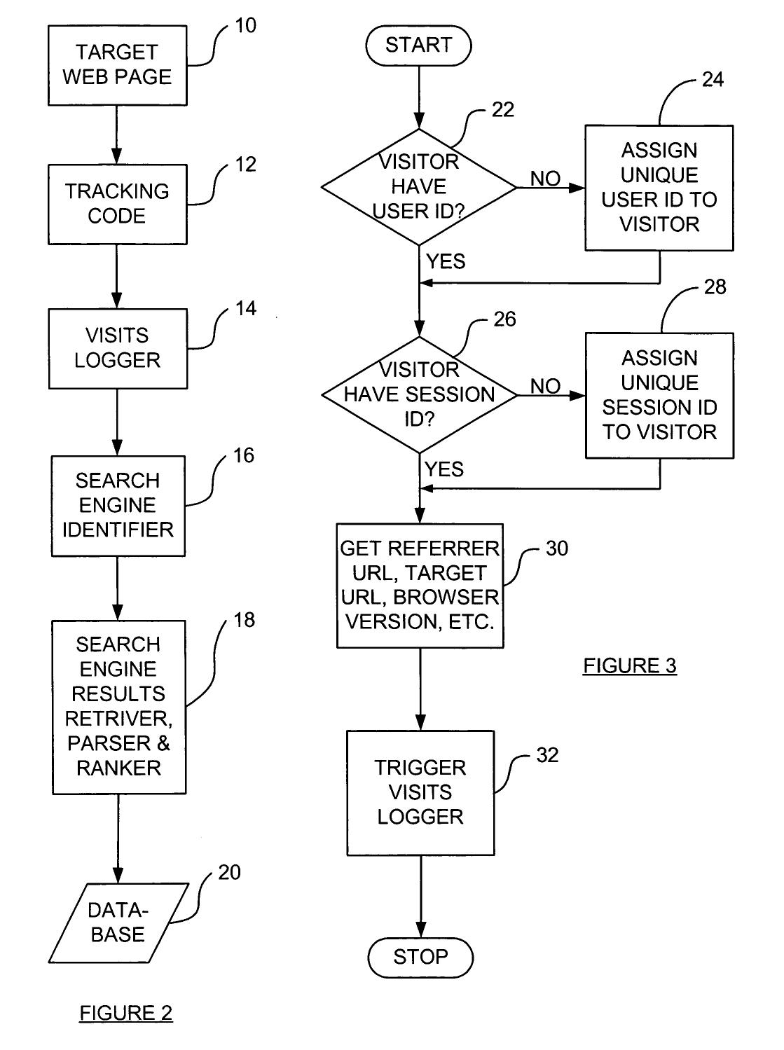

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

FIG. 2 schematically depicts a target web page 10 for which search engine and keyword information is to be dynamically tracked and ranked in accordance with the invention. A reference to JavaScript tracking code module 12 is embedded in web page 10. Tracking code module 12 is therefore automatically executed by the visitor's web browser when the browser loads web page 10, unless the visitor has adjusted the browser's settings to disable execution of script modules. Although some visitors may disable execution of script modules, most do not because doing so can adversely affect the web browsing experience with respect to many web pages.

As explained below in more detail, tracking code module 12 identifies the visitor, obtains the referrer URL and transmits that information over the Internet to visits logger 14, which runs on a remote computer controlled by the owner of target web page 10 or persons acting on the owner's behalf. Visits logger 14 creates a database entry containing the referrer URL and a time-stamped record of the visitor's current visit to web page 10. Visits logger 14 then initiates execution of search engine identifier 16, which determines whether web page 10 was accessed via a search engine and, if so, identifies the search engine and adds an identifier for the search engine to the database entry. Search engine identifier 16 then initiates execution of search engine results retriever, parser & ranker 18, which uses the referrer URL to obtain search engine search results page(s) substantially identical to the page(s) obtained by the visitor. Search engine results retriever, parser & ranker 18 searches the results page(s) to locate a link to the target web page (i.e. the target URL), determines whether the target URL is a sponsored link, parses the target URL to locate within it any keyword(s) the visitor typed into the search engine, and adds the target URL and keyword(s) to the database entry with “rank” information representative of the target URL's position relative to the start of the results page(s).

The target web page-embedded reference to tracking code module 12 may for example have the form:

< script src = “/Tracking.js” > < /script >

where “Tracking.js” is the JavaScript file containing tracking code module 12. Execution of tracking code module 12 returns another script reference to the browser, having the following form:

< script src=“http://net-radar.com/BugsyMQ.asp?UserID=40970059846053&
SessionID=5310473139920&TimeZone=420&referrer=http%3A//www.altavista.
com/web/results%3Fq%3DMichael+B.+Rings%26kgs%3D0%26kls%3D1%26
avkw%3Daapt&target=http%3A//www.pearlmansjewelers.com/michaelb.html&
browser=Microsoft%20Internet%20Explorer&operatingSystem=4.0%20%28compatible%
3B%20MSIE%206.0%3B%20Windows%20NT%205.0%3B%20.NET%
20CLR%201.0.3705%3B%20.NET%20CLR%201.1.4322%29&screenHeight=
864&screenWidth=1152&colorDepth=32&pageTitle=Pearlmans%20Jewelers%
3A%20Michael%20B.%20Jewelry%3A%20Cutting%20Edge%20and%20Elegant%
20Platinum%20Jewelry&version=1.1” > < /script >

where “net-radar.com” is the domain at which tracking code module 12 is hosted. The remainder of the returned script reference consists of parameters derived by tracking code module 12, as explained below. Because tracking code module 12 returns a script reference to the browser, the browser automatically attempts to retrieve the referenced script, in this example from http://net-radar.com/BugsyMQ.asp. This returns to the browser a JavaScript file containing a null command while forwarding the aforementioned parameters to the domain at which tracking code module 12 is hosted, for further processing as explained below. Examination of above example returned script reference reveals parameters such as user ID, session ID, time zone, referrer URL, target URL, browser ID, etc. Examination of the referrer URL (http://www.altavista.com/web/results?q=Michael+B.+Rings&kgs=0 &kls=1&avkw=aapt) reveals that the search engine in this example is the AltaVista™ search engine (i.e. http://www.altavista.com), and that the user typed the keywords “Michael B. Rings” into that search engine. The target URL in the foregoing example is http://www.pearlmansjewelers.com/michaelb.html Persons skilled in the art will note that some minor URL encoding is performed to prevent corruption of collected information by the hypertext transfer protocol (HTTP).

For purposes of this invention, the primary parameters of interest are the referrer URL and the target URL. However the following description makes reference to some of the other parameters, such as referrer URL-embedded search engine identifier and keyword(s), user ID session ID, etc. to give persons skilled in the art a contextual framework for better understanding of the invention.

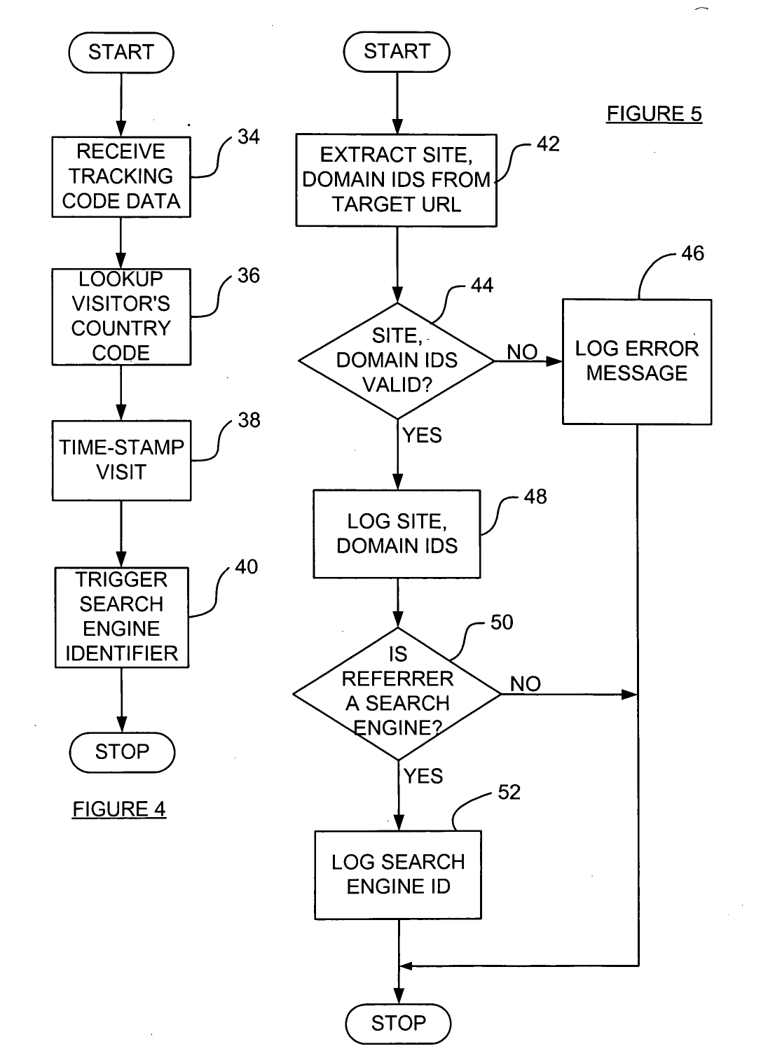

As shown in FIG. 3, tracking module 12 performs a test (block 22) to determine whether a user ID has previously been allocated to the visitor. The visitor can be identified by means of the hostname or numerical IP address information associated with the visitor. Tracking module 12 extracts that information from the visitor's web browser and compares the extracted information with a visitor-identifier table identifying the target web page's previous visitors. If the block 22 test result is negative (block 22, “No” output) then a unique user ID is allocated to the visitor (block 24) and added to the visitor-identifier table.

If the block 22 test result is positive (block 22, “Yes” output), or after the block 24 user ID allocation step, another test (block 26) is performed to determine whether a non-expired session ID has been allocated to distinguish the visitor's current visit to web page 10 from previous visits. If the block 26 test result is negative (block 26, “No” output) then a unique session ID is allocated to the visitor's current visit to web page 10 (block 28) and added to a session-identifier table.

If the block 26 test result is positive (block 26, “Yes” output), or after the block 28 session ID allocation step, the referrer URL is obtained (block 30) via the document.referrer environment variable, together with additional information such as the visitor's browser type and version, and associated with the previously derived user ID and session ID parameters. Tracking module 12 then passes (block 32) the accumulated parameters to visits logger 14.

The search engine results page(s) produced by a search engine for a given keyword or keywords may vary, depending on the geographic location of the computer used to access the search engine. This is because some search engines attempt to bias search results for the geographic location of the computer used to access the search engine. Thus, a computer user in Toronto who types the keyword “travel” into a search engine may obtain search engine results page(s) with links to web pages for Canadian travel service providers near the top of the first results page, whereas a user in Los Angeles who simultaneously types the same keyword into the same search engine may obtain a different set of search engine results page(s) with links to web pages for U.S. travel service providers near the top of the first results page. As previously explained, any ranking of a target web page should ideally reflect the position of the target web page's link on the results page(s) the visitor actually saw. Consequently, it is preferable to take the visitor's geographic location into account to improve the likelihood of obtaining results page(s) substantially identical to the page(s) obtained by the visitor.

Under the currently used IPv4 Internet protocol addressing scheme, it is only possible to determine a country corresponding to the location of a computer used to access a search engine. When fully implemented, the IPv6 extension to the Internet protocol addressing scheme will potentially make it possible to obtain much more precise geographic location information for a computer used to access a search engine. For present purposes, the visitor's IPv4 address is utilized, together with one of a number of geographically specific databases made available by the Internet Assigned Numbers Authority (IANA). Specifically, the American Registry for Internet Numbers (ARIN) database encompasses IPv4 addresses allocated for use by computers located in North America and sub-Sahara Africa; the Asia Pacific Network Information Centre (APNIC) database encompasses IPv4 addresses allocated for use by computers in the Asia/Pacific region; the Regional LatinAmerican and Caribbean IP Address Registry (LACNIC) database encompasses IPv4 addresses allocated for use by computers in Latin America and some Caribbean Islands; and, the Réseaux IP Européens (RIPE NCC) database encompasses IPv4 addresses allocated for use by computers in Europe, the Middle East, Central Asia, and African countries located north of the equator.

The appropriate database (identifiable by examining the visitor's IPv4 address, since IPv4 addresses are allocated in regionally specific blocks) is used to construct a binary tree of IPv4 address ranges with leaf nodes indicating country codes. The visitor's IPv4 address is then used to traverse the tree until a leaf node is reached. The country code corresponding to that leaf node is assumed to identify the country location of the computer the visitor used to access the search engine. However, this technique is not foolproof because IPv4 address allocations change regularly. Moreover, the aforementioned IANA databases are managed in different ways by different parties.

Having identified the country corresponding to the visitor's IPv4 address, one may then use a proxy server to obtain geographic region-specific search results pages from a search engine. For example, if it is determined that the visitor's IPv4 address is associated with the United States, then a proxy server located in the United States is used to query the search engine so that any search engine-imposed United States biasing reflected in the search engine results pages seen by the visitor will also be reflected in the search engine results pages obtained by search engine results retriever, parser & ranker 18.

Persons skilled in the art will appreciate that the invention is readily adaptable for use with IPv6 addresses, once the IPv6 extension to the Internet protocol addressing scheme is fully implemented. Such implementation may result in assignment of blocks of IP addresses on a regional basis. This will in turn enable search engine providers to bias search engine results pages on a regionally specific basis. In such case, it will become necessary to provide appropriate regionally-located proxy servers for querying search engines on a corresponding regionally specific basis, so that any search engine-imposed regional biasing reflected in the search engine results pages seen by a visitor will also be reflected in the search engine results pages obtained by search engine results retriever, parser & ranker 18.

As shown in FIG. 4, after receiving (block 34) the parameters passed to it by tracking module 12, visits logger 14 derives (block 36) country code information using the visitor's IP address and the aforementioned IANA databases. The derived country code is associated with the previously derived user ID, session ID and referrer URL parameters. A record of the current date and time is then associated (block 38) with the aforementioned parameters and the parameters are passed (block 40) to search engine identifier 16.

As shown in FIG. 5, search engine identifier 16 extracts (block 42) from the target URL the domain name representative of the target web page the visitor is attempting to access via the referrer URL. The extracted domain name is then used to look-up siteID and domainID parameters for the target web page. Specifically, the siteID parameter identifies a specific set of web pages (potentially spanning multiple web sites). The domainID parameter identifies a specific domain name used to access a web site (this parameter is required because multiple domain names can be associated with a single web site). The domain name is readily extracted via a simple text search, by focusing on predefined text string portions of the referrer URL.

A test (block 44) is then performed to determine whether the extracted domain name is valid. This is necessary because it is conceivable that a script reference to tracking code module 12 may be inadvertently or maliciously copied to a web page other than the target web page(s) of interest. If the extracted domain name does not correspond to the target web page(s) of interest then no matching siteID and domainID parameters are found and the extracted domain name is deemed to be invalid. If the block 44 test result is negative (block 44, “No” output; i.e. if matching siteID and domainID parameters are not found) then an error message is logged (block 46) for future consideration and search engine identifier 16 terminates execution by updating database 20 to indicate that no ranking results were produced for the visitor's current visit to web page 10. This ensures that ranking results produced in accordance with the invention are not skewed by association with web pages other than the target web page. If the block 44 test result is positive (block 44, “Yes” output), then the siteID and domainID information is associated (block 48) with the previously accumulated user ID, session ID, referrer URL, country code, date, time and target URL parameters.

A test (block 50) is then performed to determine whether the referrer URL was produced by a search engine. This is done by parsing the referrer URL by comparing a predetermined text string portion of the referrer URL to a table of predefined text strings representative of known search engines. The predefined text strings can be produced by typing into each search engine of interest keywords expected to produce a referrer URL for target web page 10, examining the results produced by the search engine to locate the referrer URL for target web page 10, inspecting and extracting from that referrer URL the text string representative of the search engine domain name (i.e. google.com, search.yahoo.com, etc.) and saving the extracted text string. If the predetermined text string portion of the referrer URL matches one of the text strings in the table it is assumed that the referrer URL was produced by the search engine corresponding to the matched text string. If the block 50 test result is negative (block 50, “No” output-that is, if the block 50 test is unable to match the referrer URL to one of the text strings in the table) then it is assumed that the referrer URL was not produced by a search engine and search engine identifier 16 terminates execution by updating database 20 to indicate that no ranking results could be produced for the visitor's current visit to web page 10. If the block 50 test result is positive (block 50, “Yes” output), then a search engine identifier such as the predefined text string representative of the search engine is associated (block 52) with the user ID, session ID, referrer URL, country code, date, time, target URL, siteID and domainID parameters.

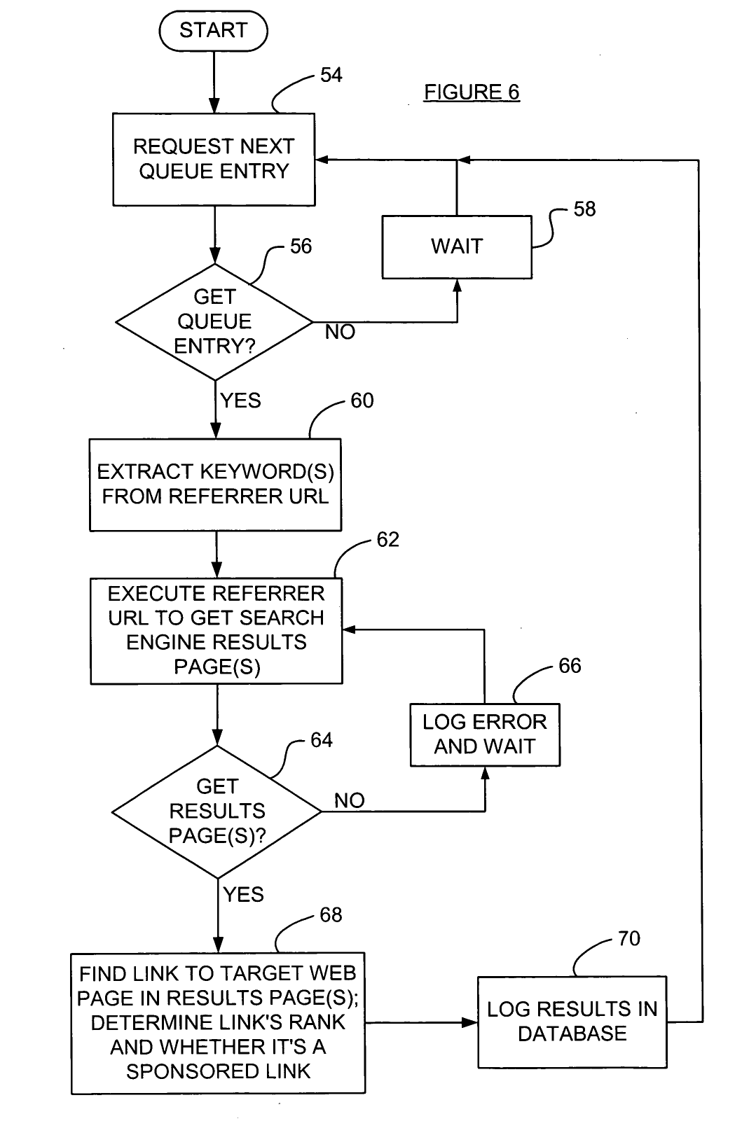

As shown in FIG. 6, search engine results retriever, parser & ranker 18 continually inspects (block 54) a queue containing entries consisting of the aforementioned user ID, session ID, referrer URL, country code, date, time, target URL, siteID, domainID, and search engine identifier parameters for each unique visitor-session. An initial test (block 56) is performed to determine whether the queue contains an entry which has not been examined. If the block 56 test result is negative (block 56, “No” output) then search engine results retriever, parser & ranker 18 waits (block 58) a predetermined time interval then again performs the block 54 queue inspection step. If the block 56 test result is positive (block 56, “Yes” output—that is, if the queue contains an unexamined entry), search engine results retriever, parser & ranker 18 retrieves the referrer URL portion of the unexamined queue entry and extracts (block 60) from the retrieved referrer URL any keyword(s) contained therein. The keyword(s) are readily extracted from the retrieved referrer URL via a simple text search, by focusing on predefined text string portions of the referrer URLs produced by each search engine of interest.

Search engine results retriever, parser & ranker 18 then executes (block 62)—if necessary via a proxy server located in the geographic region corresponding to the country code contained in the queue entry—a request for the retrieved referrer URL in order to obtain search engine search results page(s) substantially identical to the page(s) obtained by the visitor for whom the retrieved referrer URL was originally produced. A test (block 64) is then performed to determine whether the search engine search results page(s) were successfully obtained. If the block 64 test result is negative (block 64, “No” output) then an error message is logged (block 66) for future consideration and processing continues, after a suitable time interval, with repetition of the block 62 referrer URL request execution step. If the block 64 test result is positive (block 64, “Yes” output), the links on the search engine search results page(s) are examined (block 68) one-by-one until a link to target web page 10 (i.e. the target URL contained in the queue entry) is located. The ordinal position or rank (i.e. 1^{st}, 2^{nd}, 3^{rd}, etc.) of the located target URL relative to the first link on the search engine search results page(s) is also noted and recorded. Search engine results retriever, parser & ranker 18 also determines whether the located target URL is a sponsored link. This can be achieved by locating any “sponsor” label associated with the link, or on the basis of special positioning of the link (as previously explained, sponsored links typically appear above or to the right of any non-sponsored links on the search results pages, and may be labeled “sponsored” links or the like). The located target URL, the target URL's rank and any sponsorship information pertaining to the target URL is stored (block 70) in database 20.

The contents of database 20 can be displayed in known fashion in any desired format, correlated with any available converted visitor information for the target web page, used to detect trends in visitors' search engine and keyword preferences for locating and linking to the target web page, etc. Such trend information can in turn be used to optimize the target web page, using techniques which are well known to persons skilled in the art, in order to improve the target web page's rank on search results pages produced by selected search engines for selected keywords. The object of such optimization is to improve the likelihood that potential visitors who type the selected keyword(s) into the selected search engine will notice a link to the target web page while reviewing the search engine's results page(s) and use that link to view the target web page. Conversely, such trend information can be used to avoid allocation of resources to optimization of the target web page for search engine and keyword combinations which are infrequently used by actual (particularly, converted) visitors to the target web page.

The Internet is highly volatile in the sense that the content on Internet-accessible web pages changes constantly. Search engines attempt to index millions of web pages per day in an effort to present their users with search results pages containing links to web pages having current content relevant to the users' search queries. Consequently, the results produced by any search engine for predefined keywords changes over time. By obtaining the target web page visitor's referrer URL when the visitor accesses the target web page, using the referrer URL to contemporaneously retrieve search engine results page(s), and determining the rank of the link to the target web page on the retrieved results page(s), the invention maximizes the likelihood that the determined rank accurately corresponds to the position of the target web page's link on the search engine results page(s) the visitor actually reviewed before selecting the target URL.

Unlike prior art techniques requiring a priori determination of keywords for which the target web page is to be optimized, the invention facilitates tracking of all keywords which visitors to the target web page actually use to locate the target web page. This facilitates optimization of the target web page for more frequently used keywords and avoids wasting optimization effort on less frequently used keywords.

Unlike prior art techniques which provide potentially outdated ranking reports based on keywords extracted from historical log files, the invention dynamically facilitates current, continuously updatable ranking of visitors' keywords. The invention also facilitates real-time monitoring of sponsored links' efficacy in producing visitors (particularly converted visitors) to the target web page, potentially facilitating more effective adjustment of web-based advertising campaigns.

As will be apparent to those skilled in the art in light of the foregoing disclosure, many alterations and modifications are possible in the practice of this invention without departing from the spirit or scope thereof. As previously mentioned, the invention is of general application and encompasses web page referrers besides search engine referrers. For example, a referrer web page may contain a link (i.e. referrer URL) to the target web page. That link may have one of a number of different forms. If the target web page is www.pearlmansjewelers.com/ the referrer web page might contain a referrer URL link to the target web page such as:

A great selection of diamond engagement rings can be found < a
href=“http:/www.pearlmansjewelers.com/” >here< /a >.

The invention facilitates determination of the fact that the text embedded in the above link (i.e. the word “here”) has no useful keyword relevance to the target web page. Specifically, if a user views a web page containing the above link and clicks the link, the user's web browser links to the target web page. Tracking code module 12 is thereupon executed and obtains the referrer URL for the web page from which the web browser loaded the target web page, as previously explained. A request for a web page corresponding to the referrer URL is then issued to obtain an alternate referrer page substantially similar to the referrer page. The alternate referrer page can then be parsed, in well-known fashion, to locate the referrer URL and its embedded keywords (in this example, the word “here”). Since the keyword “here” has no useful relevance to the target web page, the referrer URL in this example is of relatively low quality. If it is desired to improve the quality of the referrer URL, the owner of the target web page could contact the owner of the web page containing the referrer URL and attempt to negotiate a modification to the referrer URL. For example, the referrer URL could be modified to contain the more relevant keyword phrase “Diamond Engagement Rings” as follows:

Pearlmans Jewelwers has a great selection of <a
href=“http:/www.pearlmansjewelers.com/”>Diamond Engagement
Rings</a>

The referrer URL to the target web page might alternatively be embedded in a graphic image on a referrer web page. Search engine search results pages typically do not reveal the contents of images, and therefore are not useful in analyzing image referrers. The invention can however be used to analyze image referrers—an alternate referrer page substantially similar to the referrer page is initially obtained, as outlined in the preceding example. The alternate referrer page can then be examined to locate and parse any image referrers, including their embedded keywords. Other aspects of the alternate referrer page (such as the dynamic nature of any links on the alternate referrer page, the density of keywords on the alternate referrer page, the number of outgoing links on the alternate referrer page, etc.) can also be analyzed as aids to assessing the alternate referrer page's overall quality as a referrer for the target web page. If the alternate referrer page contains many keywords having little or no relevance to the target web page, or many outgoing links to pages other than the target web page, there may be little point investing effort in attempting to improve the quality of the link on the web page containing the referrer URL corresponding to the alternate referrer page. But, such effort may be justified if the majority of the alternate referrer page's keywords are relevant to the target web page and if there are comparatively few outgoing links to pages other than the target web page on the alternate referrer page.

As another example, in the case of a search engine referrer, it may not always be necessary to execute the block 62 request for the retrieved referrer URL in order to obtain a fresh set of search engine search results pages. Suppose that target web page 10 is very frequently accessed by many users who all use the same keyword(s) and search engine. In such case, the search engine search results pages can be cached, and a fresh set of search engine search results pages obtained only after expiry of a predefined time interval such as 5 minutes. This avoids unnecessary consumption of computing resources, network bandwidth, etc. Over a relatively short interval such as 5 minutes, the cached search engine search results pages are likely to remain substantially identical to the page(s) obtained by the visitor for whom the retrieved referrer URL was originally produced.

As a further example, although it is desirable to execute the block 62 request for the retrieved referrer URL as soon as possible, in order to obtain search engine search results pages substantially identical to those obtained by the visitor for whom the retrieved referrer URL was originally produced, one may delay execution of the block 62 request for the retrieved referrer URL for a predefined time interval of reasonable duration. Thus, although the content on Internet-accessible web pages changes constantly, the likelihood is that search results pages produced by a given search engine for given keyword(s) will not change significantly over a short time interval of about one hour. Conceivably, the queue from which the block 54 inspection step retrieves entries may accumulate a large number of entries, with insufficient computing resources, network bandwidth, etc. being available to rapidly process the queue entries. Delayed processing of such entries for a time interval of reasonably short duration such as one hour should not unduly impair ranking results obtained in accordance with the invention.

The scope of the invention is to be construed in accordance with the substance defined by the following claims.

1. A method of producing an alternate referrer page substantially similar to a referrer page previously viewed, through a web browser, by a visitor who linked to a target web page via a link on the previously viewed referrer page, the method comprising, when the web browser links to the target web page:
(a) obtaining a referrer URL for the web page from which the web browser loaded the target web page; and,
(b) issuing a request for a web page corresponding to the referrer URL to obtain the alternate referrer page.

2. A method as defined in claim 1, further comprising:
(a) obtaining the IP address of the computer running the web browser;
(b) determining a country code corresponding to the IP address; and,
(c) issuing the request for a web page corresponding to the referrer URL through a computer located in a geographic region corresponding to the country code.

3. A method as defined in claim 1, further comprising:
(a) locating, in the previously produced referrer page, a target URL for the target web page;
(b) determining the target URL's position within the previously produced referrer page; and,
(c) storing the target URL and the target URL's position.

4. A method as defined in claim 3, further comprising obtaining the referrer URL by embedding a web browser-executable code module in the target web page and executing the code module when the web browser loads the target web page.

5. A method as defined in claim 1, further comprising:
(a) caching the alternate referrer page for a predetermined time interval;
(b) if another visitor links to the target web page within the predetermined time interval, determining whether the referrer URL obtained for said another visitor corresponds to the cached referrer page; and,
(c) if the referrer URL obtained for said another visitor corresponds to the cached referrer page, providing the cached referrer page as the alternate referrer page without issuing a request for a web page corresponding to the referrer URL.

6. A method as defined in claim 1, further comprising delaying for a time interval shorter than a predetermined time interval, issuing the request for a web page corresponding to the referrer URL.

7. A method of producing alternate referrer pages substantially similar to referrer pages previously viewed, through a web browser, by a visitor who linked to a target web page via a link on the previously viewed referrer pages, the method comprising, when the web browser links to the target web page:
(a) obtaining a referrer URL for the web page from which the web browser loaded the target web page;
(b) obtaining the IP address of the computer running the web browser;
(c) determining a country code corresponding to the IP address;
(d) creating a queue entry containing the referrer URL and the country code;
(e) inspecting the queue at predefined time intervals to determine whether the queue contains an unexamined entry; and,
(f) if the queue contains an unexamined entry, issuing a request for the referrer URL contained in the unexamined entry through a computer located in a geographic region corresponding to the country code contained in the unexamined entry, to obtain the alternate referrer pages.

8. A method of producing alternate search engine search results pages substantially similar to search engine search results pages previously viewed, through a web browser, by a visitor who supplied one or more keywords to a search engine and linked to a target web page via a link on the previously viewed search engine search results pages, the method comprising, when the web browser links to the target web page:
(a) obtaining a referrer URL for the web page from which the web browser loaded the target web page;
(b) parsing the referrer URL to determine whether the referrer URL contains a search engine identifier for a predefined search engine;
(c) if the referrer URL contains a search engine identifier for a predefined search engine, further parsing the referrer URL to locate any keywords contained in the referrer URL; and,
(d) if the referrer URL contains any keywords, issuing to the predefined search engine a search request for the keywords contained in the referrer URL to obtain the alternate search engine search results pages from the search engine.

9. A method as defined in claim 8, further comprising:
(a) obtaining the IP address of the computer running the web browser;
(b) determining a country code corresponding to the IP address; and,
(c) issuing the search request to the predefined search engine through a computer located in a geographic region corresponding to the country code.

10. A method as defined in claim 8, further comprising:
(a) searching the alternate search engine search results pages to locate a target URL for the target web page within the alternate search engine search results pages;
(b) determining the target URL's position relative to the start of the alternate search engine search results pages and assigning that position as the target URL's rank; and,
(c) storing the target URL, the target URL's rank, the keywords and the search engine identifier.

11. A method as defined in claim 10, further comprising, before parsing the referrer URL to determine whether the referrer URL contains a search engine identifier:
(a) extracting site ID and domain ID parameters from the target URL; and,
(b) if the extracted site ID and domain ID parameters do not correspond to a predefined target web page, terminating the method.

12. A method as defined in claim 10, further comprising obtaining the referrer URL by embedding a web browser-executable code module in the target web page and executing the code module when the web browser loads the target web page.

13. A method as defined in claim 8, further comprising:
(a) caching the alternate search engine search results pages for a predetermined time interval;
(b) if another visitor links to the target web page within the predetermined time interval, determining whether the referrer URL obtained for said another visitor corresponds to the cached search engine search results pages; and,
(c) if the referrer URL obtained for said another visitor corresponds to the cached search engine search results pages, providing the cached search engine search results pages as the alternate search engine search results pages without issuing a search request to the predefined search engine.

14. A method as defined in claim 8, further comprising delaying for a time interval shorter than a predetermined time interval, issuing a search request to the predefined search engine.

15. A method of producing alternate search engine search results pages substantially similar to search engine search results pages previously viewed, through a web browser, by a visitor who supplied one or more keywords to a search engine and linked to a target web page via a link on the previously viewed search engine search results pages, the method comprising, when the web browser links to the target web page:
(a) obtaining a referrer URL for the web page from which the web browser loaded the target web page;
(b) parsing the referrer URL to determine whether the referrer URL contains a search engine identifier for a predefined search engine;
(c) if the referrer URL contains a search engine identifier for a predefined search engine, further parsing the referrer URL to locate any keywords contained in the referrer URL;
(d) obtaining the IP address of the computer running the web browser and determining a country code corresponding to the IP address;
(e) creating a queue entry containing the referrer URL, the search engine identifier, the keywords and the country code;
(f) inspecting the queue at predefined time intervals to determine whether the queue contains an unexamined entry; and,
(g) if the queue contains an unexamined entry, issuing to the predefined search engine, through a computer located in a geographic region corresponding to the country code contained in the unexamined entry, a search request for the keywords in the referrer URL contained in the unexamined entry to obtain the alternate search engine search results pages.
